(19) United States
(12) Patent Application Publication
(10) Pub. No.: US 2025/0340392 A1
(43) Pub. Date: Nov. 6, 2025

(54) PAPER SHEET SEPARATION TRANSPORT DEVICE AND PAPER SHEET HANDLING DEVICE

(71) Applicant: JAPAN CASH MACHINE CO., LTD., Osaka (JP)

(72) Inventor: Kenichi ITO, Osaka (JP)

(21) Appl. No.: 19/191,939

(22) Filed: Apr. 28, 2025

(30) Foreign Application Priority Data
May 1, 2024 (JP) 2024-074337

(51) Int. Cl. B65H 3/06; B65H 5/06

(52) U.S. Cl. CPC B65H 3/06; B65H 5/06; B65H 2402/441; B65H 2701/1912

(57) ABSTRACT

A paper sheet separation transport device and a paper sheet handling device designed for improved paper jam processing work and other internal maintenance. A feed roller, frictional separating member, drawing transport part that draws out one separated paper sheet, and an axis support part supports at least a set-out roller and the feed roller about an axis to be rotationally movable between a processing enable position and a processing disable position, and the feed roller is at a position adjacent to the drawing transport part when the set-out roller and the feed roller are at the processing enable position, and the feed roller is separated away from the drawing transport part when the set-out roller and the feed roller are retracted to the processing disable position.

### CROSS-REFERENCE

This application is based upon and claims the benefit of priority to Japanese Patent Application No. 2024-074337, filed on May 1, 2024, with the Japanese Patent Office, the entire contents of which are incorporated herein by reference in its entirety.

### FIELD OF THE INVENTION

The embodiments of the present invention relate to a paper sheet separation transport device and a paper sheet handling device.

### BACKGROUND

A banknote separation transport device that takes out a banknote one by one from a bundle of banknotes set on a deposit part and transports the banknote to store the banknote in a cashbox is installed in a banknote handling device such as a banknote deposit machine, a banknote counting machine, various types of automatic vending machines, or a game media dispensing machine in a game hall.

For example, in a banknote separation transport device installed in a retail store, banknotes of sales collected from cash registers are received and collectively managed.

A multi-feed prevention mechanism is installed in the banknote separation transport device because accurate processing such as deposit processing and count processing including recognition is interrupted if multiple banknotes try to pass. One banknote having passed through the multi-feed prevention mechanism is subjected to judgment of authenticity, denomination, and the like by a recognition device and a banknote that is judged to be acceptable is stored in the cashbox.

Typically, only persons with special authority, such as security companies that perform guarded transport of cash, are allowed to detach the cashbox or access banknotes therein. Meanwhile, when the device is stopped due to occurrence of a jam or the like on a banknote transport route upstream of the cashbox, jam processing by normal administrators is often required. That is, the cashbox being a security area and the upstream transport route not being the security area are separated in advance, and jams occurring on the upstream transport route can be processed by normal administrators. At the request for enhancement of convenience in the jam processing, it is demanded that the jam processing is possible while the banknote separation transport device remains installed in the banknote handling device.

A bulk document feeder (a document processing device) of U.S. Pat. No. 8,662,490 shows a bulk feeder module including a pickup part that takes out a banknote one by one from a paper sheet bundle set on a tray and transports the banknote, a separating part that separates multi-fed paper sheets, and a drawing part that draws out a paper sheet separated by the separating part and transports the paper sheet downstream, an acceptor module that transports a paper sheet having passed through the drawing part toward a cashbox, and the cashbox arranged immediately below these modules. The bulk feeder module is removably combined with the accepter module. While a door that enables an access to the cashbox is arranged to close the front surface of the bulk feeder module, a narrow opening that receives paper sheets on the tray is formed on the door. A bezel including the tray is attached to the outer side of the opening and detached therefrom.

In this conventional example, the opening described above is used to enable the jam processing while the banknote separation transport device remains installed in the banknote handling device. That is, when a jam occurs on the transport route, the bezel including the tray is detached to expose the opening. When a jam occurrence position is an inside position that can be seen from the opening, the jam processing is performed by work from outside using the opening. A feeder pulley constituting the pickup part, a high friction pulley constituting the separating part, and a part of the drawing part are formed as a cartridge and this cartridge is configured to be detachable from the remaining part of the bulk feeder module by an operation from the opening when a jam occurs in a deep part that cannot be seen from the opening. The deep part of the banknote transport route can be exposed by removal of the detached cartridge to outside through the opening, so that processing of a jammed banknote occurring in the deep part of the acceptor module can be performed by an operation from the opening.

Meanwhile, in a state where the bulk feeder module and the acceptor module are left in the banknote handling device, there is a limitation in the range of jams that can be processed by the operation through the narrow opening. Processing jams occurring in the acceptor module located downstream is particularly difficult. Accordingly, the bulk feeder module and the acceptor module are configured to be detachable from the module including the cashbox to enable jam processing outside the banknote handling device.

However, also in this case, the jam processing of a deep part of the device after detachment of the cartridge is an operation from the narrow opening and accordingly the workability is low. The workability of cleaning the transport rollers and optical components of a tracking sensor located in the deep part of the device is also low. Therefore, redressing of these problems has been demanded.

### SUMMARY OF THE INVENTION

The embodiments of the present invention have been made in view of the above problems, and has an object to provide a paper sheet separation transport device and a paper sheet handling device having improved maintenance workability associated with a jam and other problems.

In order to solve the above problems, a paper sheet separation transport device according to the embodiments of the present invention include a first module in which a paper sheet reception processing unit is fixed to a paper sheet storage processing unit, a downstream module removably coupled to the first module, and a controller that controls various control targets, wherein the paper sheet reception processing unit includes a frame with an opening on a front surface to receive paper sheets, a paper feed tray removably attached to the front surface of the frame, a set-out roller that sets out paper sheets from a paper sheet bundle on the paper feed tray, a feed roller and a frictional separating member constituting a separating part that separates paper sheets set out by the set-out roller in a multi-fed state into one sheet, a drawing transport part that draws out one paper sheet separated by the separating part to send the paper sheet downstream, and an axis support part that supports at least the set-out roller and the feed roller on the frame about an axis to be pivotable between a processing enable position where paper sheet transport processing is enabled and a processing disable position where paper sheet transport processing is disabled, and the feed roller is at a position near the drawing transport part when the set-out roller and the feed roller are at the processing enable position, and the feed roller is separated from the drawing transport part when the set-out roller and the feed roller are retracted to the processing disable position.

According to the embodiments of the present invention, it is possible to provide a paper sheet separation transport device and a paper sheet handling device that are improved in maintenance workability with a jam and other problems.

### BRIEF DESCRIPTION OF DRAWINGS

FIG. 1 is an exterior perspective view of one embodiment of a paper sheet separation transport device according to the embodiments of the present invention;

FIG. 2A is an exterior perspective view illustrating a state where a rotationally-moving open/close mechanism of the paper sheet separation transport device is at an initial position according to the embodiments of the present invention;

FIG. 2B is a vertical sectional view illustrating an internal configuration of the paper sheet separation transport device from FIG. 2A according to the embodiments of the present invention;

FIG. 3A is an exterior perspective view illustrating a state where the rotationally-moving open/close mechanism of the paper sheet separation transport device is at a first open position according to the embodiments of the present invention;

FIG. 3B is a vertical sectional view illustrating an internal configuration of the paper sheet separation transport device from FIG. 3A according to the embodiments of the present invention;

FIG. 4A is an exterior perspective view illustrating a state where the rotationally-moving open/close mechanism of the paper sheet separation transport device is at a second open position according to the embodiments of the present invention;

FIG. 4B is a vertical sectional view illustrating an internal configuration of the paper sheet separation transport device from FIG. 4A according to the embodiments of the present invention;

FIG. 5A is an exterior perspective view illustrating a state where the rotationally-moving open/close mechanism of the paper sheet separation transport device is at a third open position according to the embodiments of the present invention;

FIG. 5B is a vertical sectional view illustrating an internal configuration of the paper sheet separation transport device is at a third open position according to the embodiments of the present invention;

FIG. 6 is a perspective view illustrating an embodiment of a set-out part, a separating part, and a drawing transport part according to embodiments of the present invention;

FIG. 7A is a first diagram illustrating attached and detached structures of a paper feed tray according to embodiments of the present invention;

FIG. 7B is a second diagram illustrating attached and detached structures of a paper feed tray according to embodiments of the present invention;

FIG. 7C is a third diagram illustrating attached and detached structures of a paper feed tray according to embodiments of the present invention;

FIG. 8A is a perspective view of an opening exposed by detachment of the paper feed tray from a bezel in an initial state where the rotationally-moving open/close mechanism is at an initial position and the periphery thereof according to embodiments of the present invention;

FIG. 8B is an (X-X) vertical sectional view of relevant parts in FIG. 8A according to embodiments of the present invention;

FIG. 9A is a diagram illustrating an operation of related components in a case where a latch mechanism that actuates the rotationally-moving open/close mechanism is operated from the front surface side according to embodiments of the present invention;

FIG. 9B is a diagram illustrating an operation of the related components in a case where the latch mechanism is operated from the side surface side according to embodiments of the present invention;

FIG. 10 is a diagram of relevant parts, illustrating a detailed configuration of the latch mechanism according to embodiments of the present invention;

FIG. 11 is a perspective view illustrating a lock mechanism L and peripheral components according to embodiments of the present invention;

FIG. 12A is a first vertical sectional view of relevant parts in FIG. 11 according to embodiments of the present invention;

FIG. 12B is a second vertical sectional view of relevant parts in FIG. 11 according to embodiments of the present invention;

FIG. 13 is a gear arrangement diagram illustrating a relation between movable components illustrated in FIGS. 2 and 6, and gears that transmit drive forces to the movable components according to embodiments of the present invention;

FIG. 14A is a first diagram illustrating a process in which a rotationally-moving open/close mechanism A rotationally moves from the initial position to a third open position, and illustrating which gears are mounted on a first movable base and a second movable base according to embodiments of the present invention;

FIG. 14B is a second diagram illustrating a process in which a rotationally-moving open/close mechanism A rotationally moves from the initial position to a third open position, and illustrating which gears are mounted on a first movable base and a second movable base according to embodiments of the present invention;

FIG. 14C is a third diagram illustrating a process in which a rotationally-moving open/close mechanism A rotationally moves from the initial position to a third open position, and illustrating which gears are mounted on a first movable base and a second movable base according to embodiments of the present invention; and

FIG. 14D is a fourth diagram illustrating a process in which a rotationally-moving open/close mechanism A rotationally moves from the initial position to a third open position, and illustrating which gears are mounted on a first movable base and a second movable base.

### DESCRIPTION OF EMBODIMENTS

The embodiments of the present invention will be described in detail below with embodiments illustrated in the drawings. However, constituent elements, types, combinations, shapes, relative arrangements thereof, and the like described in the embodiments are not intended to limit the scope of the present invention thereto and are merely explanatory examples unless specifically described.

### Descriptions of Basic Configuration

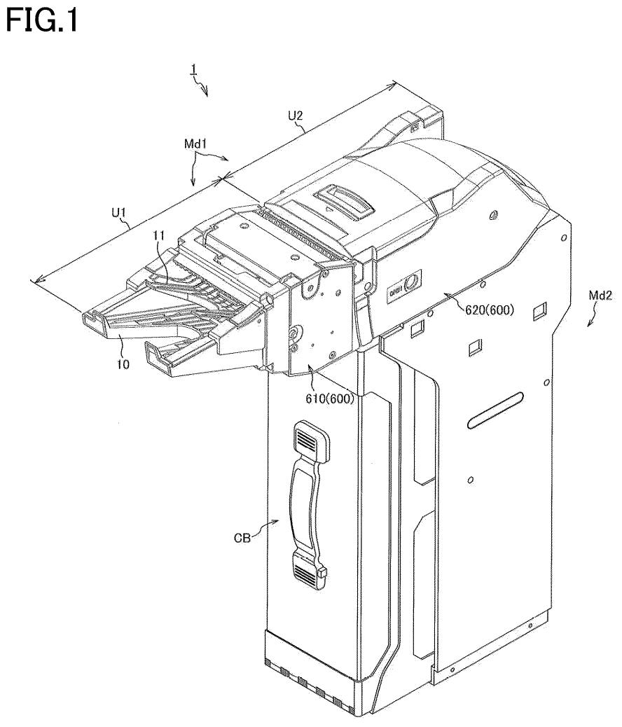

FIG. 1 is an exterior perspective view of one embodiment of a paper sheet separation transport device according to the embodiments of the present invention.

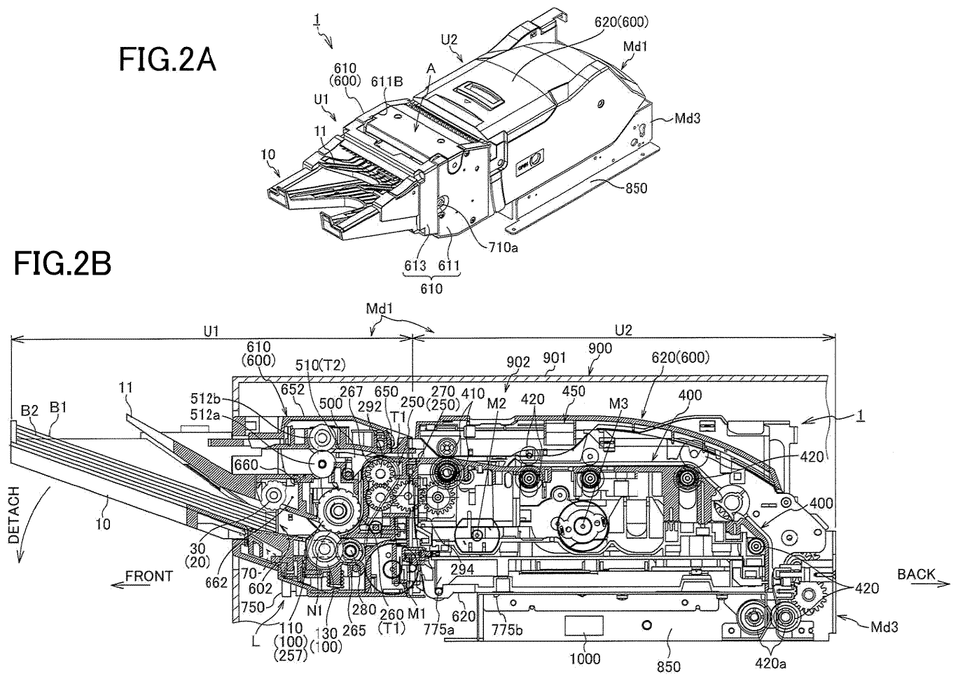

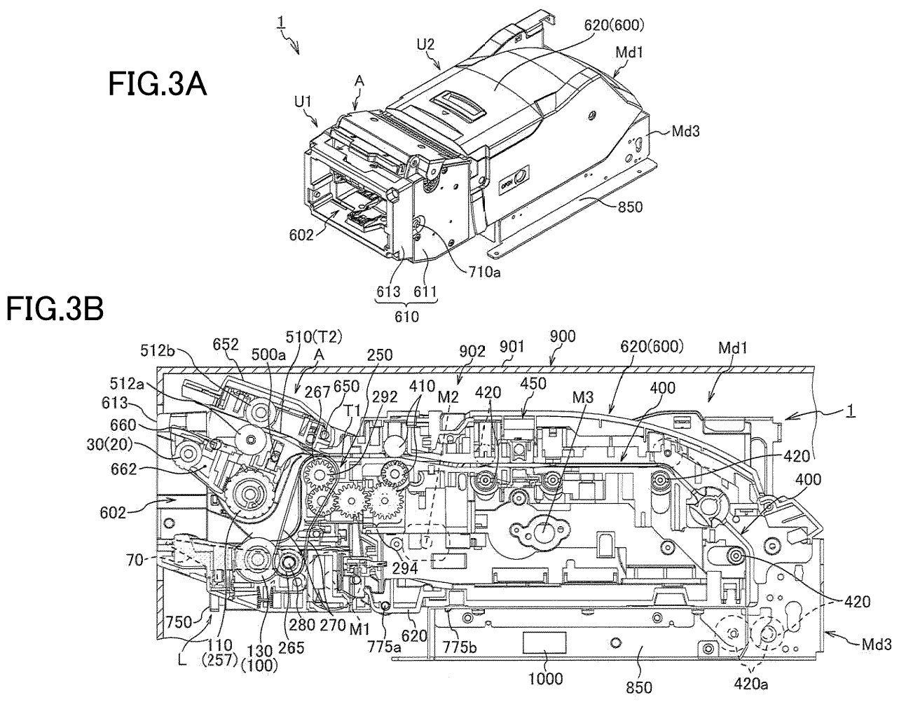

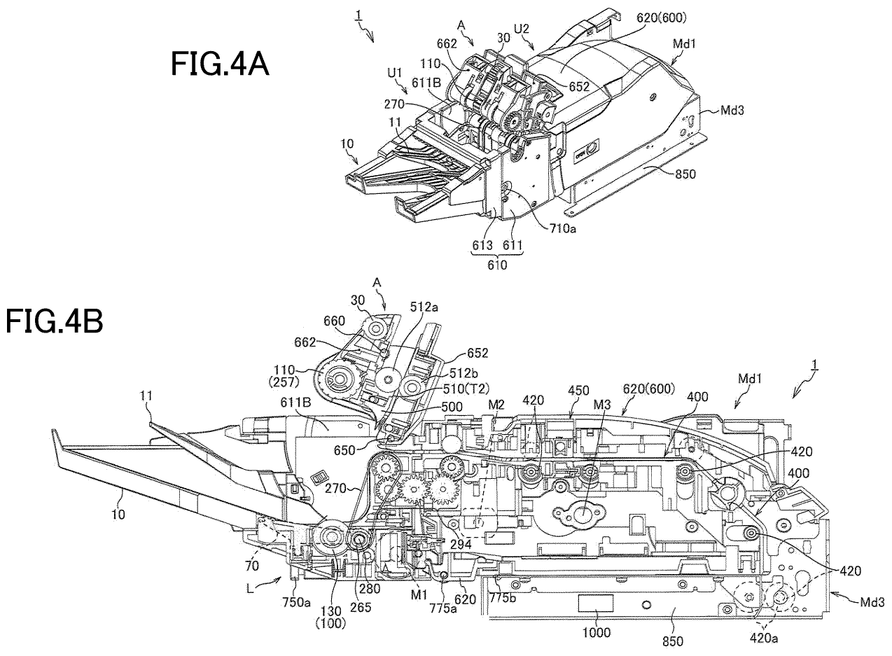

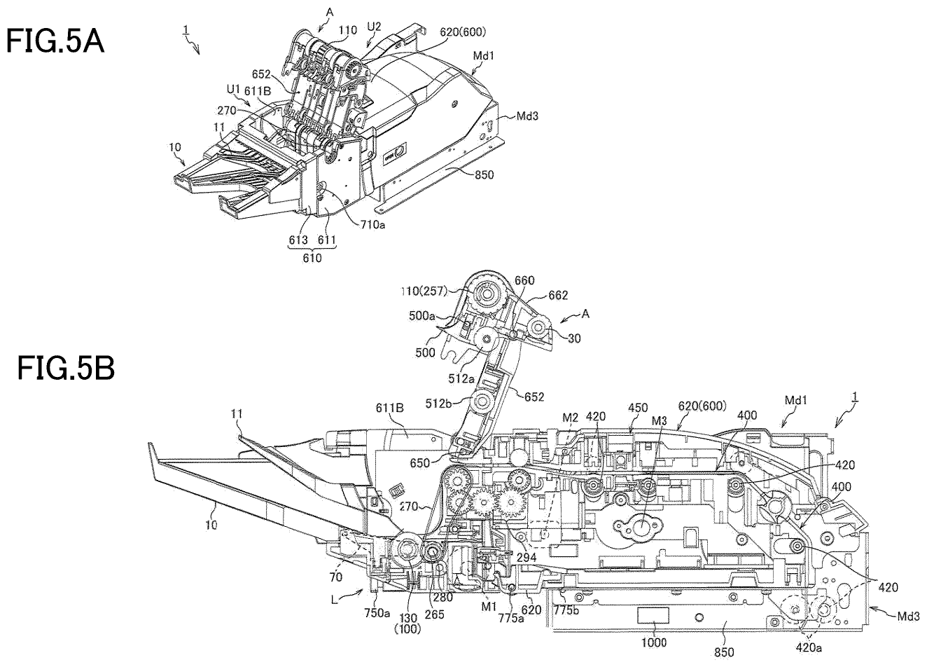

FIGS. 2 to 5 are front views illustrating an internal configuration of the paper sheet separation transport device, and operations thereof. FIGS. 2A and 2B are an exterior perspective view illustrating a state where a rotationally-moving open/close mechanism A of the paper sheet separation transport device is at an initial position, and a vertical sectional view illustrating an internal configuration thereof, FIGS. 3A and 3B are an exterior perspective view illustrating a state where the rotationally-moving open/close mechanism of the paper sheet separation transport device is at a first open position, and a vertical sectional view illustrating an internal configuration thereof, FIGS. 4A and 4B are an exterior perspective view illustrating a state where the rotationally-moving open/close mechanism of the paper sheet separation transport device is at a second open position, and a vertical sectional view illustrating an internal configuration thereof, and FIGS. 5A and 5B are an exterior perspective view illustrating a state where the rotationally-moving open/close mechanism of the paper sheet separation transport device is at a third open position, and a vertical sectional view illustrating an internal configuration thereof.

While banknotes are primarily described as one example of paper sheets in the present specification, the present device is also applicable to separation and transport of paper sheets other than banknotes. Paper sheets also include sheets made of a resin or other materials as well as sheets made of paper.

A banknote separation transport device 1 is a unit that can be installed in or provided along with a banknote handling device such as a banknote deposit machine, an automatic vending machine, a game media dispensing machine in a game hall or casino to perform processing of receiving banknotes and discharging rejected banknotes.

The banknote separation transport device 1 is described in detail below. The banknote separation transport device 1 schematically includes a first module Md1 including a deposit processing unit (a paper sheet reception processing unit) U1 and a storage processing unit (a paper sheet storage processing unit) U2, a downstream module (a second module Md2 or a third module Md3) removably coupled to the first module Md1, a controller (a CPU, an MPU, a ROM, a RAM, and the like) 1000 that controls various control targets, and the like.

As illustrated in FIG. 1, the second module Md2 is a module that has a cashbox CB incorporated therein and that receives banknotes discharged from the first module Md1 (the storage processing unit U2) to store the banknotes in the cashbox while putting the banknotes in order.

In addition to the second module Md2, the third module Md3 that does not include a cashbox and that performs reception processing of banknotes discretely discharged from the storage processing unit U2 is also connectable to the storage processing unit U2. For purposes of brevity and required information to describe the present invention, the entire exterior configuration of the third module is not particularly illustrated and only a base board 850 as a connection part to the storage processing unit U2 is illustrated.

In the embodiment illustrated in FIGS. 2A and 2B and subsequent drawings, a configuration is shown wherein third module Md3 is connected downstream of the banknote storage processing unit U2 via the base board 850. However, exclusion of a configuration example in which the second module Md2 is connected thereto is not intended. Hereinafter, each of the second module Md2 and the third module Md3 is also referred to as “downstream module.”

The deposit processing unit U1 is a unit that receives a deposited banknote to transport the banknote to the storage processing unit U2 or discharges a rejected banknote returned from the storage processing unit U2 to outside the device.

The storage processing unit U2 includes a storage transport route (a storage transport mechanism) 400 that receives a banknote sent from the deposit processing unit U1 and transports the banknote to the second module Md2 or the third module Md3.

The deposit processing unit U1 includes a frame 600 including an opening 602 for receiving banknotes on the front surface, a paper feed tray (a tray, a deposit part) 10 that is removably attached to the front surface of the frame 600 (in front of the opening) and on which banknotes before being supplied into the frame 600 are placed in a stacked state, a set-out part (a set-out roller 30 and a pick pusher 70) 20 that takes out a banknote one by one from the topmost part of a banknote bundle on the paper feed tray 10 to supply the banknote into the frame 600, a separating part (a feed roller 110 and a brake roller 130) 100 that allows only a first banknote B1 to pass so as to send the banknote downstream and that blocks second and subsequent banknotes from advancing when banknotes set out by the set-out part 20 are in a multi-fed state, a drawing transport part 250 that is located close to the feed roller 110 constituting the separating part 100 to form a drawing transport route 260 and that draws out one banknote B1 having a part remaining in the separating part 100 to send the banknote downstream (toward the storage processing unit U2) by rotating forward, and a first motor M1 that drives various driven members constituting the set-out part 20 and the separating part 100 (a set-out and separation mechanism 15).

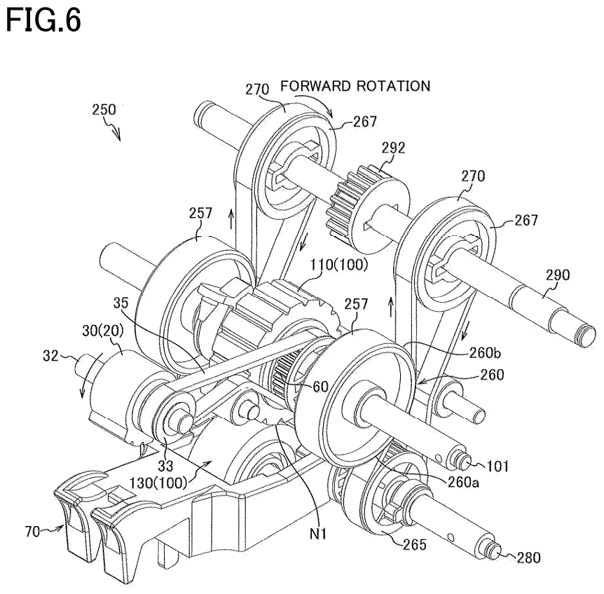

The deposit processing unit U1 further includes a first axis support part (a hinge) 650 and a second axis support part (a hinge) 660 that support the set-out roller 30, the feed roller 110, and idle rollers 257 (FIG. 6) on the frame 600 about an axis to be capable of pivoting (rotationally moving) between a transport processing enable position (FIGS. 2A and 2B) where banknote transport processing (set-out, separation, and drawing) can be performed and a transport processing disable position (FIGS. 3 to 5) where the transport processing cannot be performed, a first transport route (a first transport mechanism) T1 that transports a banknote sent from the drawing transport part 250 toward the storage processing unit U2, a second transport route (a second transport mechanism) T2 that performs return transport to a return banknote storage tray (a return banknote accumulating part) 11 that receives banknotes having been reversely sent from the storage transport route 400 of the storage processing unit U2, and a flapper 500 that is arranged at a branch point between the transport routes T1 and T2 to switch the banknote transport direction to the first transport route T1 or the second transport route T2.

Each of the first transport route T1 and the second transport route T2 is a concept including not only a mere transport path but also transport components such as transport rollers, gears, and tracking sensor arranged along the transport path.

The drawing belts 270 constituting the drawing transport part 250 form a drawing transport route 260 between the drawing belts 270 and the idle rollers 257 when the set-out roller 30, the feed roller 110, and the idle rollers 257 are at the transport processing enable position, and are separated from the idle rollers 257 to open and expose the drawing transport route 260 when the set-out roller 30, the feed roller 110, and the idle rollers 257 are retracted to the transport processing disable position. The idle rollers 257 will be described later with reference to FIG. 6 and the like.

While the drawing transport part 250 in the illustrated embodiment is constituted of the drawing belts 270 and the like, this is merely an example and the drawing transport part 250 may be replaced by, for example, a part constituted of a drawing roller pair as shown in U.S. Pat. No. 8,662,490.

The frame 600 includes a frame 610 of the deposit processing unit U1 and a frame 620 of the banknote storage processing unit U2. The frame (a fixed part) 610 of the deposit processing unit U1 includes a frame body (a fixed part) 611, and a bezel 613 fixed to a front surface opening of the frame body 611. The paper feed tray 10 is attached to or detached from the bezel 613.

A reference sign 611B in FIGS. 2A, 4A and 5A denotes an open part formed on the top surface of the frame 610. Due to presence of the open part 611B, the rotationally-moving open/close mechanism A described later can be rotationally moved to an open position illustrated in FIGS. 4 and 5. In a state where the rotationally-moving open/close mechanism A is housed inside of the open part 611B as in FIGS. 2A and 2B, the outer surface of a first movable base 652 is in a step-free state with respect to a circumferential edge part of the open part to enhance the design quality.

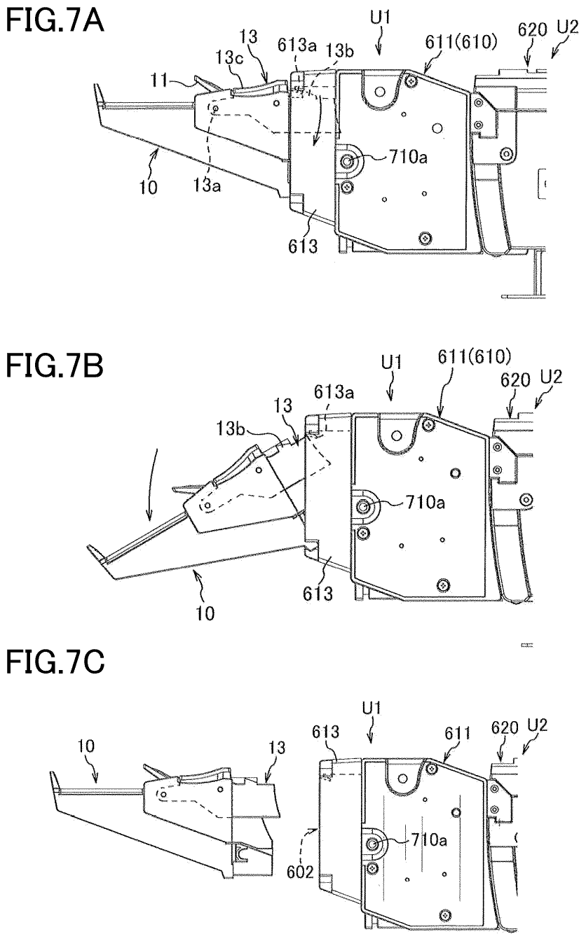

FIGS. 7A, 7B, and 7C are diagrams illustrating attached and detached structures of the paper feed tray 10. A catch click member 13 has one end part supported about an axis by a shaft 13a located at an appropriate place in an upper part of the paper feed tray 10 and is configured to be rotationally movable in the upper-lower direction. A click 13b is provided to be upturned on the other end of the catch click member 13. The catch click member 13 is biased upward around the shaft 13a by a spring (not illustrated).

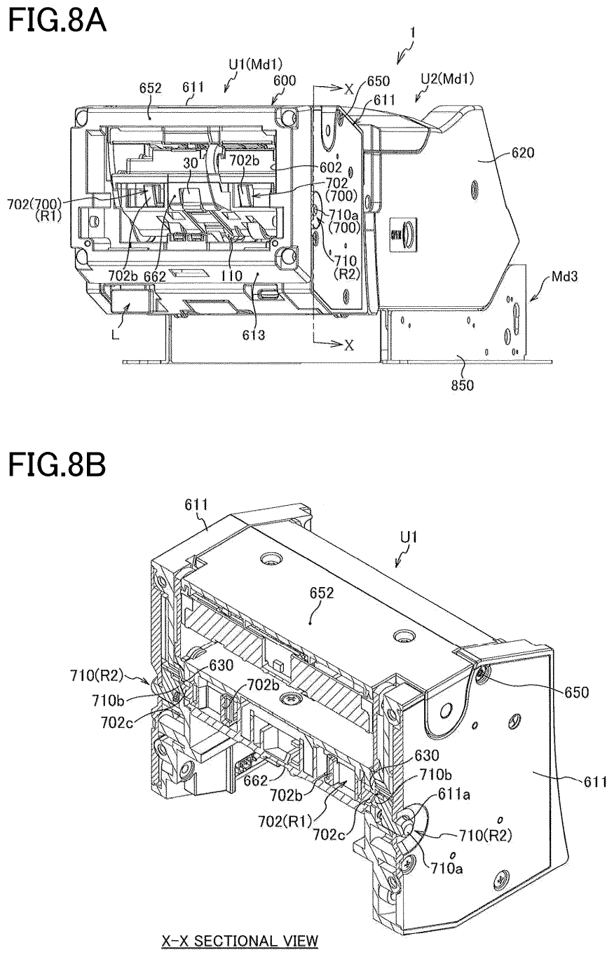

In the attached state of FIG. 7A, the click 13b is caught on a caught part 613a provided on an upper portion inside the opening of the bezel 613. When a pressing part provided on an upper part of the catch click member 13 is pushed in the state of FIG. 7A, the other end part where the click 13b is provided lowers against the spring and is separated from the caught part 613a (FIG. 7B). Accordingly, the paper feed tray 10 can be detached from the bezel 613 as illustrated in FIG. 7C. FIG. 8A is a perspective view of the inside of the opening in a state where the paper feed tray 10 is detached from the bezel 613.

This example is described assuming that the return banknote storage tray 11 is assembled to the paper feed tray 10.

As illustrated in FIGS. 2 to 5, one end part of the first movable base 652 is supported by the first axis support part 650 about an axis to be rotationally movable (pivotable) in the upper-lower direction, and a return transport route 510, that is, some of transport components constituting the second transport route (the second transport mechanism) T2, for example, a return roller 512b, gears, and the like are mounted on the first movable base 652. The second axis support part 660 is located on the other end part of the first movable base 652. The set-out roller 30, the feed roller 110, the idle rollers 257, a return roller 512a, gears that drive these components, and the like are mounted on the second movable base 662 that is supported by the second axis support part 660 about an axis to be rotationally movable in the upper-lower direction.

This embodiment of the present invention includes the drawing belts 270 as the drawing transport part 250, and it is adequate that at least the set-out roller 30 and the feed roller 110 are mounted on the second movable base 662. It suffices that the configuration enables the feed roller 110 and other components mounted on the second movable base 662 to be retracted by moving the second movable base 662 to be opened, and enables the inside of the drawing transport part 250 having been hidden by the feed roller 110 and the like to be open.

That is, while the return roller 512b is mounted on the first movable base 652, and the set-out roller 30, the feed roller 110, the idle rollers 257, and the return roller 512a are mounted on the second movable base 662 in the present embodiment, this is merely an example. Any components may be mounted as long as a banknote jammed in a deep part of the banknote transport route can be removed by opening the rotationally-moving open/close mechanism A.

The first axis support part 650, the first movable base 652, the second axis support part 660, the second movable base 662, and the components mounted on the movable bases 652, 662 constitute the rotationally-moving open/close mechanism A. The first movable base 652 and the components mounted on the first movable base 652 constitute a first rotationally moving unit, and the second movable base 662 and the components mounted on the second movable base 662 constitute a second rotationally moving unit.

In the initial state illustrated in FIGS. 2A and 2B, the first movable base 652 and the second movable base 662 are both in a closed state (the transport processing enable position), and the drawing transport route 260 is formed between the outer circumferential surfaces of the idle rollers 257 arranged on both sides of the feed roller 110 in the axial direction, and the front surfaces of the drawing belts 270. A banknote jam may occur between the feed roller 110 and the drawing belts 270.

The base board 850 illustrated in FIGS. 2A and 3A is a member constituting the third module Md3 and the coupled units U1 and U2 are attached to or detached from this base board 850 as will be described later.

In open states (the transport processing disable position) in FIGS. 3 to 5, since the idle rollers 257 and the drawing belts 270 are separated from each other, the drawing transport route 260 is not formed. The feed roller 110 is also retracted from the drawing transport route 260. Therefore, the transport processing is impossible.

That is, the idle rollers 257 mounted on the first movable base 652 are close to (in contact with) the drawing belts 270 and form the drawing transport route 260 when at the transport processing enable position illustrated in FIGS. 2A and 2B. On the other hand, when moved (retracted) to the transport processing disable position illustrated in FIGS. 3 to 5, the idle rollers 257 are separated from the drawing belts 270 to open the drawing transport route 260.

Although the two drawing belts 270 and the feed roller 110 are different in the axial position, a jammed banknote may remain also between the drawing belts 270 and the feed roller 110 when a jam occurs in the initial state illustrated in FIGS. 2A and 2B. Therefore, by moving (retraction) of the feed roller 110 to the transport processing disable position illustrated in FIGS. 3 to 5, jam processing is facilitated.

The first transport route T1 includes the drawing transport route 260 and a route from the drawing transport route 260 to the storage transport route 400. The drawing transport route 260 is a curved contact travel region formed by the idle rollers 257 and the drawing belts 270 illustrated in FIG. 6 that are in contact with each other. A banknote having passed through the drawing transport route 260 and having been transported upward is further drawn up by the drawing belts 270, is then transport upward while being guided by a transport guide member (not illustrated). The second reverse rollers 267 reversing the drawing belts 270 in the clockwise direction at an upper part guide the banknote toward the storage transport route 400 in the banknote storage processing unit U2 by rotating in the clockwise direction (rotating forward).

Flapper (a sort unit) 500 that switches the banknote transport direction, and the flapper 500 is a sort unit that guides a banknote having been transported to the position of the second reverse rollers 267 by the drawing belts 270 toward the storage transport route 400 and that guides a banknote transported reversely from the storage transport route 400 toward the return transport route 510. The flapper 500 is supported about an axis by a pivot shaft 500a provided on a lower part to be rotationally movable in the upper-lower direction closes a passage from the drawing transport route 260 toward the storage transport route 400 by lowering a right end part (a leading end part) by the own weight balance of the flapper 500 in normal times (an initial attitude). At the passing of a banknote lifted by the drawing belts 270, the right end part of the flapper 500 is pushed up by the banknote and the flapper 500 allows the banknote to move to the right. When the back end of the banknote passes the right end part of the flapper 500, the flapper 500 returns to the initial attitude.

When a banknote is moved into the storage transport route 400 and judged by a recognition unit 450 to be unacceptable, the controller 1000 causes motors M2 and M3 to reversely rotate transport members 410 and 420 constituting the storage transport route 400, thereby transporting the banknote reversely toward the flapper 500. Since the flapper 500 is in the initial attitude at this stage, the rejected banknote passes the flapper 500 from the back end part to enter the return transport route 510. A return roller pair (transport members) 512a and 512b are arranged on the return transport route 510 and are driven by the second motor M2 in a direction to discharge a banknote. The return banknote storage tray 11 is placed at the terminal end part of the return transport route 510 and discharged return banknotes are sequentially stored therein.

The return transport route 510 is arranged above and substantially parallel to a set-out route from the set-out part 20 toward the separating part 100, and the return banknote storage tray 11 is arranged above and substantially in parallel to the paper feed tray 10. In one embodiment of the present invention, the first motor M1 drives the set-out and separation mechanism (the separation unit) 15, and the transport members 512 and the return transport route 510 is driven by the second motor M2. Therefore, these components do not interfere with each other and a stable separation operation and stable return transport operation can be realized.

The storage processing unit U2 includes the storage transport route (a storage transport mechanism, a storage transport part) 400 that receives a banknote B transported by the drawing belts 270 constituting the drawing transport part 250 to transport the banknote to the inside, the recognition unit 450 that optically judges the denomination and the authenticity of a banknote transported downstream on the storage transport route 400. A banknote judged to be acceptable is transported downstream to be stored in the cashbox CB included in the second module Md2 (or stored in the third module Md3), and a banknote judged to be unacceptable (a rejected banknote) is transported reversely to be discharged to the return banknote storage tray 11 through the deposit processing unit U1. The banknote storage processing unit U2 further includes the second motor M2 that drives the transport members (such as a gear and a roller) 410 located upstream of the storage transport route 400 and the return roller pair 512a and 512b, and the third motor M3 that drives the transport members (such as a gear and a roller) 420 located downstream of the storage transport route 400. The third motor M3 drives the transport roller group 420 located from a midstream part to a downstream part of the storage transport route 400. A transport roller pair 420a located at the most downstream part of the storage transport route 400 is a unit that discharges a banknote to the downstream module Md2 or Md3.

### Descriptions of Operation of Rotationally-Moving Open/Close Mechanism A

In one embodiment of the present invention, when the first movable base 652 and the second movable base 662 are at the initial position (shown in FIGS. 2A and 2B) in a state where the banknote separation transport device 1 is attached to an attachment part 902 provided in an enclosure 901 of the banknote handling device 900. A jammed banknote visually recognized in the opening 602 can be removed from the outside (the front) of the opening 602 by separating the paper feed tray 10 (including the return banknote storage tray 11) from the frame 600 (the bezel 613) to open the opening 602.

Furthermore, in the state where the banknote separation transport device 1 is attached to the attachment part 902, the rotationally-moving open/close mechanism A, that is, the set-out roller 30, the feed roller 110, the idle rollers 257, and the like are enabled to be rotationally moved from the initial position in FIGS. 2A and 2B to a first open position in FIGS. 3A and 3B. This operation can be performed with a one-touch action by manually operating latch members 702 described later that are arranged in an exposed manner in the opening 602.

The rotationally-moving open/close mechanism A (the first and second movable bases 652, 662) is biased by an elastic member (not illustrated) in a direction rotationally moving upward on the first axis support part 650. Meanwhile, when at the initial position (a closed position) in FIGS. 2A and 2B, the rotationally-moving open/close mechanism A is caught at that position by a latch mechanism 700 described later. By operating the latch mechanism 700 from the side of the opening to cancel the catch, the rotationally-moving open/close mechanism A opens due to a force of the elastic member.

Accordingly, in a state where the banknote separation transport device 1 remains attached to the banknote handling device 900 and by separating the paper feed tray 10 from the bezel 613 to open the opening 602, the rotationally-moving open/close mechanism A can be retracted by a single touch via the opening 602 such that a jammed banknote remaining on the front surfaces of the drawing belts 270 can be processed.

When the rotationally-moving open/close mechanism A moves to the first open position in FIGS. 3A and 3B, the tension of the drawing belts 270 having been pressed by the idle rollers 257 is canceled, so that the drawing belts 270 on the front surface side stretch as illustrated. Furthermore, since the feed roller 110 is retracted upward, the front surfaces of the drawing belts 270 are exposed, and a banknote having been nipped becomes easy to separate therefrom. Accordingly, substantial jams can be processed via the opening 602.

In FIGS. 3A and 3B, banknotes jammed in various manners are enabled to be processed via the opening 602 in a state where the coupled units U1 and U2 remain connected to the third module Md3. This is because there is a case of a device configuration in which a cumbersome work of unlocking a key that fixes the coupled units U1 and U2 is required to detach these units from the downstream module. In the present embodiment, not only a jam on the front surface side that may normally occur but also a jam occurring inside can be easily processed only by rotating the rotationally-moving open/close mechanism A to the first open position shown in FIGS. 3A and 3B.

When the rotationally-moving open/close mechanism A in the open state is to be returned to the initial position shown in FIGS. 2A and 2B, it suffices to manually push down the rotationally-moving open/close mechanism A from the opening 602 to be returned to the closed state secured by the latch mechanism 700. That is, since it is unnecessary to eject the rotationally-moving open/close mechanism A from the opening 602, returning the rotationally-moving open/close mechanism A from the first open position to the initial position after the jam processing can be completed by a one-touch action.

In one embodiment, the rotational moving angle of the movable bases 652 and 662 in the state of FIGS. 3A and 3B is limited to, for example, about 20 degrees by the ceiling surface of the attachment part 902. Therefore, a jammed banknote located in such a deep part (an upper part of the front surfaces) of the drawing belts 270 that cannot be visually recognized from the opening 602 may be challenging to process in some cases. Consequently, measures are taken to process such jams as shown in FIGS. 4A, 4B, 5A and 5B.

That is, with one embodiment of the present invention, in a state where the banknote separation transport device 1 has the paper feed tray 10 attached thereto is ejected from the attachment part 902 of the banknote handling device 900, second cancel operation parts 710a provided on both side surfaces of the frame body 611 are pushed inside, thereby enabling the feed roller 110 and the idle rollers 257 constituting the rotationally-moving open/close mechanism A to rotationally move from the initial position shown in FIGS. 2A and 2B to the second open position shown in FIGS. 4A and 4B due to a force of an opening spring (not illustrated). Since the ceiling of the attachment part 902 does not interfere, the first and second movable bases 652 and 662 can be manually opened to the maximum extent on the first axis support part 650.

At the stage shown in FIGS. 4A and 4B, processing of a banknote jammed in a deep part (the drawing transport part 250) that cannot be addressed through the opening 602 and that is performed after the paper feed tray 10 is detached, as illustrated in FIGS. 3A and 3B, becomes possible. Particularly, maintenance such as removal of a jammed banknote occurring in an upper part of the front surfaces of the drawing belts 270, removal of foreign objects, and cleaning of the transport rollers and the lens of a tracking sensor, that cannot be processed in the open state shown in FIGS. 3A and 3B where the process is performed from the opening 602 can be easily performed from outside (from above, laterally, and the like). In this instance, labor is saved not having to access the opening 602 by separating the paper feed tray 10 from the bezel 613.

Furthermore, with certain of the embodiments of the present invention, a banknote jammed in the return transport route 510 can be processed by manually further opening the second movable base 662 (a second rotationally moving unit) on the second axis support part 660 with respect to the first movable base 652 (a first rotationally moving unit) being at the second open position as shown in FIGS. 4A and 4B. That is, while the transport members 512a and 512b nip and the return transport route 510 is closed in the state shown in FIGS. 4A and 4B, the return transport route 510 can be opened by opening and separating the second movable base 662 from the first movable base 652 as illustrated in FIGS. 5A and 5B.

Accessing the opening 602 as shown in FIGS. 3A, 3B, 4A and 4B can be performed in a state where the coupled units U1 and U2 are attached to the base board 850 of the downstream module.

### Latch Mechanism

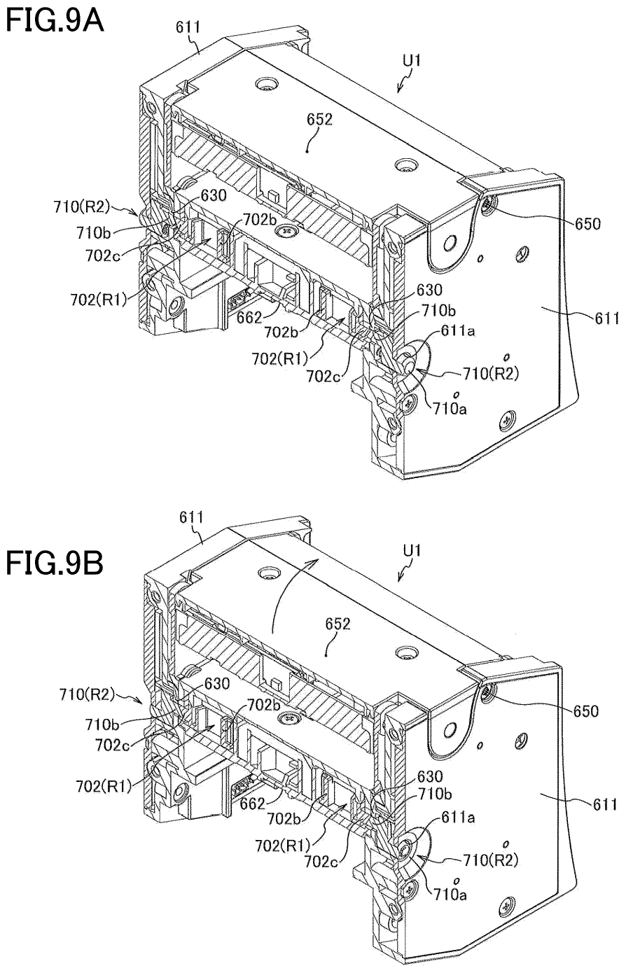

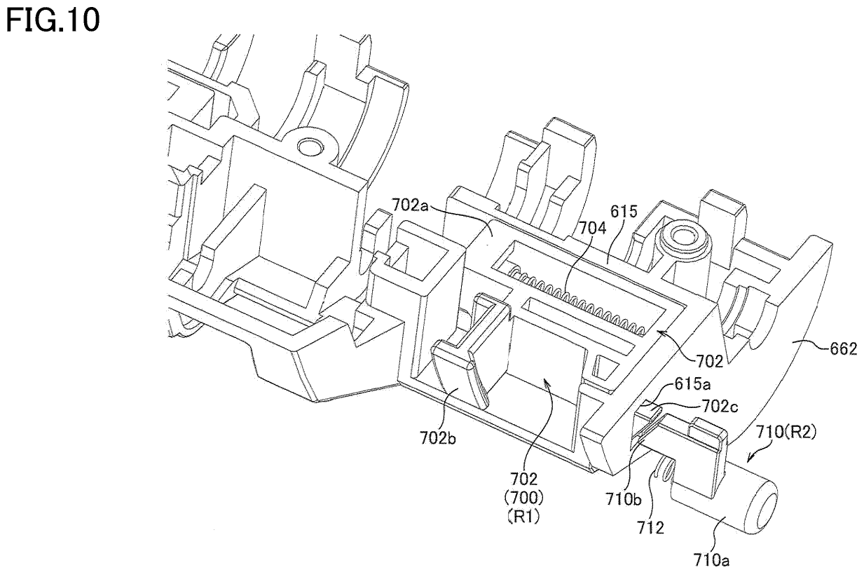

FIG. 8A is a perspective view of the inside of the opening 602 exposed by detachment of the paper feed tray 10 from the bezel 613 in the initial state where the rotationally-moving open/close mechanism A is at the initial position. FIG. 8B is an (X-X) vertical sectional view of relevant parts of FIG. 8A. FIGS. 9A and 9B correspond to vertical sectional views at the same position as that in FIG. 8B, in which FIG. 9A is a diagram illustrating an operation of related components in a case where the latch mechanism 700 is operated from the front surface side, and FIG. 9B is a diagram illustrating an operation of the related components in a case where the latch mechanism 700 is operated from the side surface. FIG. 10 is a diagram of relevant parts, illustrating a detailed configuration of the latch mechanism 700.

The latch mechanism 700 is a unit that holds the rotationally-moving open/close mechanism A in a state caught at the initial position (a transport enable attitude, a processing enable position) shown in FIGS. 2A and 2B during the operation of the device and that cancels the caught state by a cancelling operation to allow the rotationally-moving open/close mechanism A to rotationally move to the open positions (a transport disable attitude, a processing disable position) shown in FIGS. 3A, 3B, 4A, 4B, 5A and 5B during jam processing.

Being mounted on the second movable base 662, the latch mechanism 700 rotationally moves along with the rotationally-moving open/close mechanism A.

As illustrated in FIG. 10 and other figures, the latch mechanism 700 schematically includes a pair of right and left latch members 702 that are supported by a pair of right and left guide frame members 615, provided inside the frame body 611, and capable of advancing and retracting in the lateral direction. Elastic members 704 each bias outward an associated click 702c provided on an outer end part of the associated latch member 702 causing the click 702c to be caught on an associated fixed-side catch part 630 provided on the frame body (the fixed part) 611, cancelling pieces 710 that each cancel the caught state between the associated click 702c and the associated fixed-side catch part 630, and elastic members 712 that each bias the associated cancelling pieces 710 in a protruding direction.

Each of the latch members 702 includes a latch body 702a in the shape of a rectangular frame supported by the associated guide frame member 615 to be capable of advancing and retracting in the lateral direction. A first cancel operation part 702b is protruded frontward from the front surface of the latch body 702a and moves the entire latch member 702 in a direction of being released from the fixed-side catch part 630 by an operation from the front side of the opening 602. Click 702c laterally protrudes from a hole 615a provided on an outer sidewall of the guide frame member 615.

Each of the cancelling pieces 710 is retractably provided in a hole 611a provided on the side surface of the frame body 611 and moves the latch member 702 in the releasing direction when pressed inward.

Since each of the latch members 702 is pushed outward by the elastic member 704 in the initial state illustrated in FIGS. 8A and 8B, the clicks 702c are protruded to below the fixed-side catch parts 630. Accordingly, the rotationally-moving open/close mechanism A, including the first movable base 652 and the second movable base 662, is blocked from rotating upward on the first axis support part 650. When personnel insert a hand or fingers from the inner part of the opening 602 and pushes inward the first cancel operation parts 702b of the two latch members 702, the clicks 702c integrated therewith are retracted inward and are separated from the fixed-side catch parts 630 (see, FIG. 9A). This makes it possible to rotationally move the rotationally-moving open/close mechanism A in the upper direction.

The operation from the front of the latch members 702 is enabled by detachment of the paper feed tray 10 from the bezel 613 and the rotationally-moving open/close mechanism A in the state shown in FIGS. 2A and 2B is opened to the first open position shown in FIGS. 3A and 3B to enable jam processing.

On the other hand, when jam processing is performed after the banknote separation transport device 1, in a state where the paper feed tray 10 is attached thereto, is separated from the banknote handling device 900, the latch members 702 are hidden by the paper feed tray 10 and the operation cannot be performed.

Since an inner end part 710b of each of the cancelling pieces 710 is pressed outward by the click 702c of the associated latch member 702 that is pressed outward by the elastic member 704 in the initial state illustrated in FIGS. 8A and 8B, the second cancel operation part 710a on the outer end part is protruded to an outer side of the outer surface of the frame body 611. The second cancel operation parts 710a are protruded from the associated holes 611a provided on the side surfaces of the frame body 611 and accordingly can be operated by personnel even in a case where the paper feed tray 10 is set. While a state in which the paper feed tray 10 is removed is illustrated in FIG. 8A for the convenience of explanations, it is presupposed that the paper feed tray 10 is set when the second cancel operation parts 710a are operated.

If the cancelling pieces 710 on the side surfaces are exposed in the state where the banknote separation transport device 1, including in the paper feed tray 10, is attached to the banknote handling device 900 as in FIGS. 2A and 2B, there is a risk that the cancelling pieces 710 are erroneously pressed and the cancelling operation is performed. Therefore, it is preferable that the second cancel operation parts 710a are shielded by a certain covering unit.

When the coupled units U1 and U2 are ejected from the attachment part 902 and the second cancel operation parts 710a are pushed inward, the inner end parts 710b move inward and press the clicks 702c of the latch members 702 inward as shown in FIG. 9B. Accordingly, the clicks 702c retract inward and are separated from the fixed-side catch parts 630 (see, FIG. 9B). This makes it possible to rotationally move the rotationally-moving open/close mechanism A in the upper direction due to a force of the elastic member 704.

To describe the configuration of the latch mechanism 700 in other words, the latch mechanism 700 includes a first cancel mechanism R1 that enables the cancelling operation from the front only, in a state where the paper feed tray 10 is removed from the opening 602 of the reception processing unit, and a second cancel mechanism R2 that enables the cancelling operation from a direction (a side) other than the front, in a state where the paper feed tray 10 is attached to the reception processing unit.

The first cancel mechanism R1 is constituted of the latch members 702 (the first cancel operation parts 702b), the elastic members 704, the catch parts 630, and the like. The second cancel mechanism R2 is constituted of the latch members 702, the elastic members 704, the cancelling pieces 710 (the second cancel operation parts 710a), the catch parts 630, and the like.

### Lock Mechanism Between First Module and Downstream Module

While the first module Md1 (the units U1 and U2) is in a state attached to the base board 850 including the third module Md3 and removably caught by the lock mechanism L as shown in FIGS. 2A, 2B, 3A and 3B, the first module Md1 can be detached from the third module Md3 as illustrated in FIGS. 4A, 4B, 5A and 5B by cancelling the lock by the lock mechanism L by a one-touch operation.

The lock mechanism L is located to extend from a lower portion of the front surface of the deposit processing unit U1 to a lower portion of the banknote storage processing unit U2 as illustrated in FIGS. 2A, 2B, 3A, 3B, 4A, 4B, 8A and 8B. The coupled units U1 and U2 can be pulled out frontward by pushing inward on push button 750a constituting the lock mechanism L to cancel the caught state between the coupled units U1 and U2 and the base board 850.

While the base board 850 has been described as a member constituting the third module Md3 in the configuration example illustrated in the drawings, the base board 850 may be a member constituting the second module Md2.

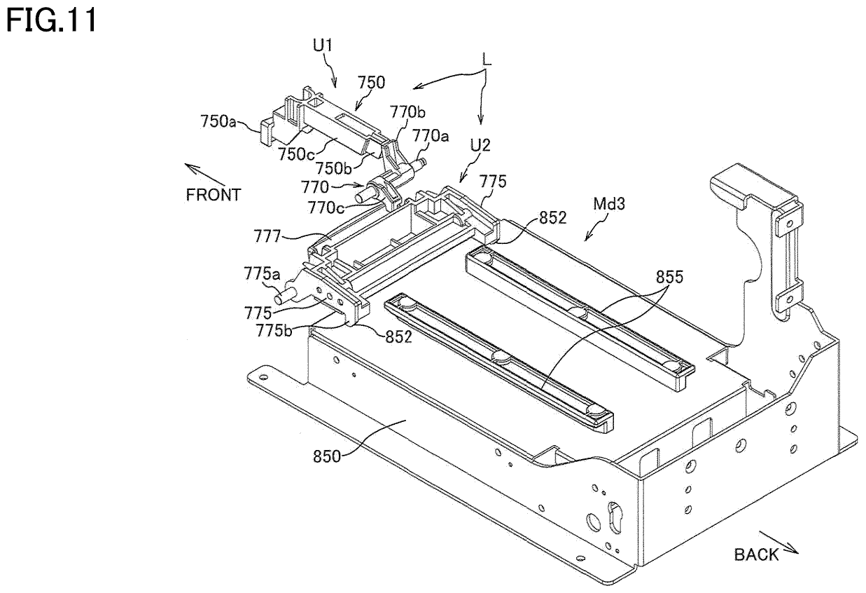

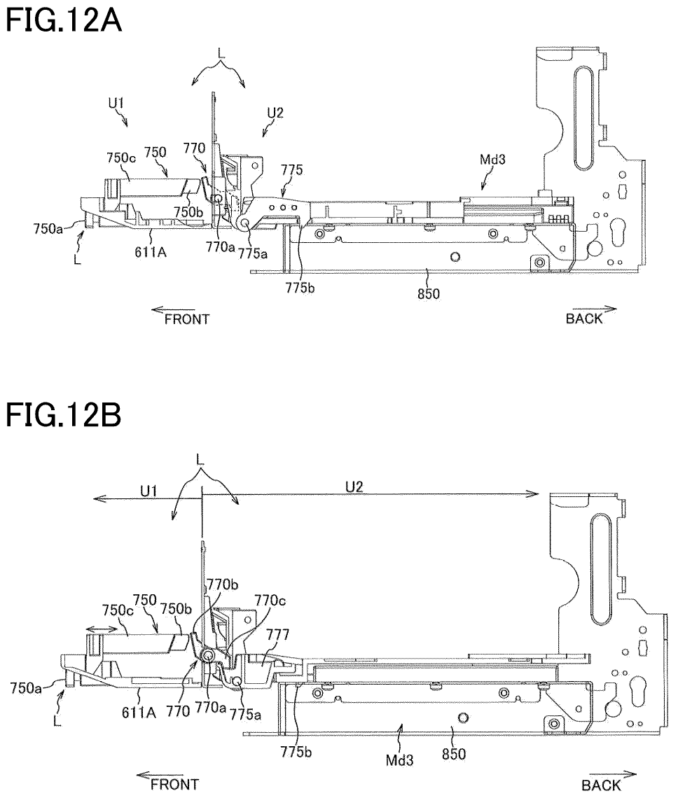

FIG. 11 is a perspective view illustrating the lock mechanism L and peripheral components, FIG. 12A is a side view of relevant parts in FIG. 11, and FIG. 12B is a vertical sectional view of relevant parts in FIG. 12A.

The lock mechanism L schematically includes a release operation piece 750 that is supported by a fixed part 611A, such as the frame body 611 of the deposit processing unit U1, to be capable of advancing and retracting in the front-back direction. An operated piece (a rotationally moving piece) 770 that is supported about an axis by a shaft 770a, which is provided on a fixed part of the frame 610 of the banknote storage processing unit U2, to be rotationally movable in the upper-lower direction and that is operated by the release operation piece 750. Two lock pieces 775 each having one end part supported about an axis by a shaft 775a, which is provided on a fixed part of the banknote storage processing unit U2, to be rotationally movable in the upper-lower direction. An intermediate piece 777 is integrated with the two lock pieces 775 at an intermediate position of the lock pieces 775 and rotationally moves in the upper-lower direction on the shaft 775a.

In the present specification, each of the frame 600, the frame body 611, and the frame 620 is a concept broadly including a fixed member (a fixed part) supporting movable members.

The release operation piece 750 includes the push button 750a exposed below the frame body 611 of the deposit processing unit U1, and a body 750c in the shape of a crank having the push button 750a at the front end and a pressing piece 750b at the back end. The release operation piece 750 is at an initial position protruded to the front illustrated in FIGS. 12 by an elastic member (not illustrated) in normal times.

The operated piece (the rotationally moving piece) 770 integrally includes a first rotationally moving piece 770b located at a position being in contact with the pressing piece 750b of the release operation piece 750, and a second rotationally moving piece 770c located at a position where a front end part of the intermediate piece 777 can be pushed down.

Each of the lock pieces 775 includes a catch click 775b protruded downward at the back end and is biased clockwise by an elastic member (not illustrated) in normal times along with the intermediate piece 777 that is integrated therewith. That is, the catch clicks 775b are biased to rotationally move downward. Holes 852 each catching an associated one of the catch clicks 775b are formed on the base board (the fixed part) 850 of the downstream module, and the catch clicks 775b biased downward are caught by these holes 852.

When the push button 750a of the release operation piece 750 is pushed, the pressing piece 750b presses the first rotationally moving piece 770b of the operated piece 770 to rotationally move the first rotationally moving piece clockwise. The second rotationally moving piece 770c then pushes the right end part of the intermediate piece 777 downward, and accordingly the lock pieces 775 integrated with the intermediate piece 777 rotationally move counterclockwise, so that the catch clicks 775b are separated from the holes 852.

When the pressing of the push button 750a is canceled, the movable components return to the original initial state by original-shape restoring forces of the associated elastic members.

Guide rails 855 provided on the upper surface of the base board 850 are configured to engage with guide rails (not illustrated) provided on the lower surface of the banknote storage processing unit U2 to attach or detach the coupled units U1 and U2.

The lock pieces 775 integrated with the intermediate piece 777 are originally a unit for causing the banknote storage processing unit U2 to be caught by the base board 850 or cancelling the catch. Accordingly, also in a state where the banknote deposit processing unit U1 is not coupled to the banknote storage processing unit U2, the lock pieces 775 can be used as a unit for removably coupling the banknote storage processing unit U2 alone to the base board 850. That is, in a state where the banknote deposit processing unit U1 is not coupled to the banknote storage processing unit U2, the end part of the intermediate piece 777 is exposed at a lower part of the front surface of the banknote storage processing unit U2. Therefore, personnel can push down this part for unlocking and can separate the banknote storage processing unit U2 from the base board 850.

In other words, it can be said that the release operation piece 750 that can be operated from the front surface side of the banknote deposit processing unit U2 is provided to actuate the lock piece 775 by an operation from the front in the state where the banknote deposit processing unit U1 is coupled to the banknote storage processing unit U2.

The push button 750a that finally separates the catch clicks 775b from the holes 852 by being pushed backward is merely an example. Alternatively, a pulling operation piece that separates the catch clicks 775b from the holes 852 by being pulled in the opposite direction to the pushing direction, that is, frontward may be provided. In this case, it suffices to change the configurations of other components (the release operation piece 750, the operated piece 770, and the intermediate piece 777) constituting the lock mechanism L to enable the catch clicks 775b to be separated from the associated holes 852 by pulling out the pulling operation piece.

### Configurations and Operations of Set-Out Part, Separating Part and Drawing Transport Part

Configurations and operations of the set-out part 20, the separating part 100, and the drawing transport part 250 are described next.

As illustrated in FIG. 6, the set-out roller 30 constituting the set-out part 20 is fixed to a shaft part 32 that rotates by drive from the first motor M1, and a downstream timing pulley 33 is coaxially fixed to the set-out roller 30 on the side of one surface thereof. The downstream timing pulley 33 receives the drive from the first motor M1 via a timing belt 35 provided endlessly in a tensioned manner between the downstream timing pulley and an upstream timing pulley 60 provided on the side of the feed roller 110.

The separating part 100 includes a feed roller shaft 101 driven by the first motor M1, the feed roller 110 that is supported by the feed roller shaft 101 to be rotatable on the axis thereof, and that is brought into contact with a surface of a first banknote set out by the set-out part 20 to transport the first banknote when rotating forward, and the brake roller (a frictional separating member) 130 that forms a separation nip part N1 with the feed roller 110 to block second and subsequent banknotes from advancing. The feed roller 110 may have a configuration in which the axis thereof is fixed to the feed roller shaft 101 to enable both to rotate together. However, in a case where a backlash formation unit to provide a backlash in a circumferential direction with the feed roller shaft 101 is adopted, the feed roller 110 is not necessarily directly fixed to the feed roller shaft 101.

The drawing transport part 250 includes at least two idle rollers (freely rotating members) 257 that are supported about an axis (unfixed in the rotation direction and fixed in the position in the axial direction) at feed roller shaft 101 portions on both sides of the feed roller 110 in the axial direction to be rotatable, and endless drawing belts 270 that are each in contact with the curved outer circumferential surface of an associated idle roller 257 to form the curved drawing transport route (a drawing nip part) 260 and that rotate (rotate forward) in the drawing direction to turn a first banknote in a direction (obliquely upward) intersecting with the direction of set-out by the set-out part 20 (the direction in which the banknote passes the separation nip part N1) in cooperation with the idle rollers 257 to transport the banknote.

Each of the drawing belts 270 is endlessly provided in a tensioned manner by a first reverse roller (a driven roller) 265 that is arranged to form the drawing transport route 260 with the outer circumferential surface of the associated idle roller 257, and the second reverse roller (a driving roller) 267. The first reverse rollers 265 form a banknote introducing part 260a of the drawing transport route 260 between the drawing belts 270 and the associated idle rollers 257. The second reverse rollers 267 reverse the associated drawing belts 270 to cause a banknote introduced from the banknote introducing part 260a to be transported toward the storage transport route 400 after passing through a downstream end part (a banknote discharge part) 260b of the drawing transport route 260. Each of the first reverse rollers 265 has an axis rotatably supported in a free unfixed state by a first shaft 280 that is rotationally driven by the first motor M1. That is, the first reverse rollers 265 are driven rollers that do not rotate to follow the rotation of the first shaft 280. The drawing belts 270 are driven by the rotation of the associated second reverse rollers 267 functioning as driving rollers.

The feed roller 110 and the idle rollers 257 are coaxially assembled on the feed roller shaft 101 and the outer circumferential surfaces thereof are located at substantially the same positions in the radial direction. Therefore, while the feed roller 110 is slightly in contact with a central portion of a banknote, there is no positive grip and a large transport resistance is not produced.

The drawing belts 270 draw up a banknote having passed through the separation nip part N1 and the feed roller 110 is rotationally driven by a minimum necessary angle only at the time of separation. Accordingly, the feed roller 110 is not involved with the operation of drawing up a banknote after the separation and does not have a function to draw up a banknote.

It is preferable that the circumferential surfaces of the idle rollers 257 are decreased in the friction to such an extent that slip occurs between the circumferential surfaces and a banknote. The circumferential surfaces of the drawing belts 270 are increased in the friction to such an extent that slip is unlikely to occur between the circumferential surfaces and a banknote.

The idle rollers 257 function to bring the drawing belts 270 into contact with a banknote, and a banknote is pressed against the outer circumferential surfaces of a low frictional resistance of the idle rollers 257 due to the tension applied to the drawing belts 270, and produces a transport grip force in cooperation with the frictional resistances of the drawing belts 270.

In one embodiment, the idle rollers 257 are made of a rigid material that is not flexurally deformed by a pressure from the drawing belts 270. In one embodiment, the width of the outer circumferential surface of each of the idle rollers 257 is substantially the same as that of the associated drawing belt 270 in the form of a narrow band or wider than the width of the drawing belt 270.

While being a direction upward by about 90 degrees in FIG. 6, the “direction intersecting with the direction of set-out by the set-out part” broadly includes directions bent or curved upward (non-parallel directions) with respect to the surface direction of banknotes set out on the paper feed tray 10.

The banknote introducing part 260a of the drawing transport route 260 is formed at a portion where the drawing belt 270 having been turned to the upper direction by the first reverse roller 265 rotating in the clockwise direction is first brought into contact with the outer circumferential surface of the idle roller 257. One banknote having passed through the separation nip part N1 is brought into contact with the drawing belt surface (a portion inclined to the obliquely upper right direction shown in FIGS. 2A and 2B and other figures) before the banknote introducing part 260a, so that the banknote is smoothly drawn obliquely upward to be immediately drawn into the banknote introducing part 260a.

The banknote having passed through the banknote discharge part 260b is transported upward by the drawing belt 270, and is subsequently introduced to the inlet of the storage transport route 400 along a reverse route between the outer circumferences of the second reverse rollers 267 and a transport guide member 301.

The idle rollers 257 held by the tension of the drawing belts 270 idle with respect to the feed roller shaft 101 and accordingly are not dependent on the driving or the rotation speed of the feed roller shaft 101. While the feed roller 110 and the idle rollers 257 are arranged on the same feed roller shaft 101, these rollers are arranged at different positions in the axial direction, whereby the separation nip part N1 as a separation point and the drawing transport route 260 (the banknote introducing part 260a) as a pull-out point can be separated. Furthermore, because of configuring the drawing transport route 260 with the traveling drawing belts 270, the distance between the separation nip part N1 and the banknote introducing part 260a in the side surface view can be freely set to any minimum necessary value. Specifically, great reduction of the distance, for example, to be smaller than the diameter or the radius of the feed roller 110 is possible.

The pick pusher 70 has a base end part fixedly supported by the first shaft 280, thereby lifting the distal end and pushing upward the banknote bundle on the paper feed tray 10 toward the set-out roller 30 to bring the banknote bundle into contact with the set-out roller 30 when the first shaft 280 rotationally moves clockwise. When the first shaft 280 is reversely rotated, the pick pusher 70 descends. A torque limiter (not illustrated) is placed between the pick pusher 70 and the first shaft 280 and is slipped to prevent the banknote bundle from being pushed up with an excessive force.

Each of the second reverse rollers (driving rollers) 267 has an axis fixedly supported by a second shaft 290 arranged above and in parallel to the first shaft 280, and a transmission gear 292 is fixed on the second shaft 290 at an intermediate position between the two second reverse rollers 267. The transmission gear 292 is connected to mesh with a gear group 294 that transmits a rotational drive force from the second motor M2. Therefore, the drawing transport part 250 is driven by the second motor M2 that drives upstream transport member 410 of the storage transport route 400.

As described above, according to the embodiments of the present invention, the set-out part 20 and the separating part 100 are driven by the first motor M1 while the drawing transport part 250 is driven by the second motor M2 via the gear groups 294 and 292. Therefore, the set-out and separating operation and the drawing transport operation can be driven and controlled independently.

Although the length of banknotes varies by country, if the timing for drawing a banknote from the separating part 100 is uniform, the banknote cannot be drawn out at an appropriate timing corresponding to the difference in the length of banknotes. With the embodiments of the present invention, since drive of the drawing transport part 250 is performed by the second motor M2 independent of drive of the separating part 100, a banknote can be drawn out at an appropriate timing after separation corresponding to the difference in conditions such as the length of the banknote. Accordingly, limitations arising from the difference in conditions are reduced and thus reliable drawing can be made.

Since the transport by the drawing belts 270 that travel endlessly is adopted to pull out a banknote by the drawing transport part 250, a nonlinear transport path where the drawing transport part 250 is bent (curved) upward with respect to the transport direction of the set-out part 20 and the separating part 100 can be formed to realize downsizing. Also in this downsized configuration, the flexibility in arrangement of components can be increased, and reliable banknote separation and drawing transport can be performed.

Even in such a nonlinear downsized device configuration where the banknote transport route is bent or curved in a substantially L-shaped manner, the set-out and separation mechanism 15 and the drawing transport part 250 can be independently controlled in the speed and the operation by driving the drawing transport part 250 with the second motor M2 that drives another driving mechanism adjacent thereto, that is, the upstream transport member 410 of the storage transport route 400, and a reliable separation and drawing transport operation can be performed.

In order to reliably draw out a banknote separated by the separating part 100, the transport speed (drive force) at the time of drawing needs to be higher (larger) than the transport speed (drive force) at the time of separation. This transport speed difference can be realized by a mechanical structure such as gears using one drive source, without provision of individual drive sources. However, in such a case, for example, when the drawing speed of the drawing transport part 250 is to be 30% higher than the transport speed of the separating part 100, this speed difference cannot be realized unless a combination of many complicated gears is adopted. In contrast thereto, with the embodiments of the present invention, the separating part 100 and the drawing transport part 250 are predetermined to be driven by the motors M1 and M2 independent of each other. Therefore, control of the speed difference can be executed considerably easily and freely without complicating the mechanical configuration or increasing the number of components. Furthermore, the second motor M2 is not a motor arranged in the deposit processing unit U1, but a motor arranged in the adjacent different banknote storage processing unit U2. Therefore, an increase in the size of the deposit processing unit U1 can be prevented.

### Gear Group Mounted on Rotationally-Moving Open/Close Mechanism

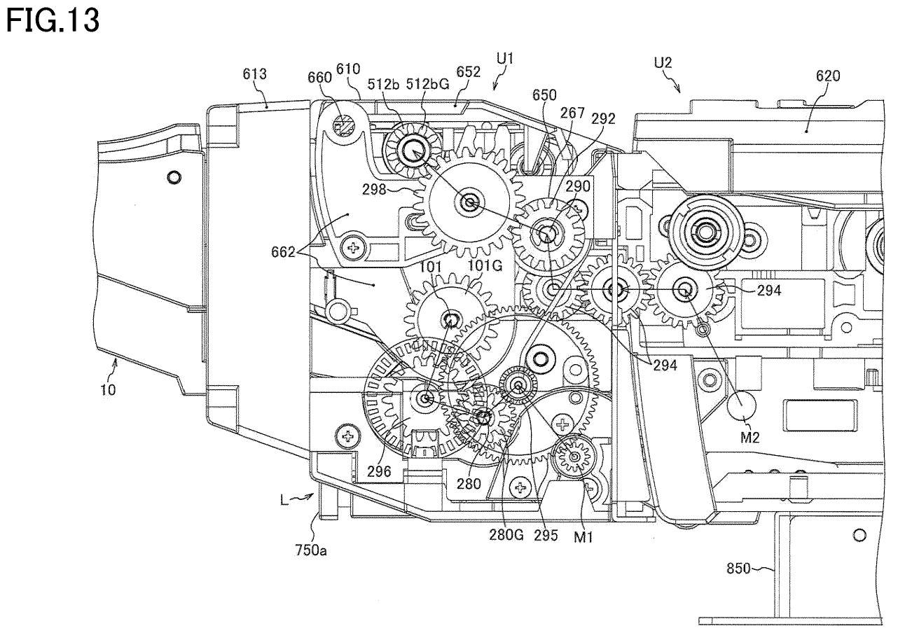

FIG. 13 shows a gear arrangement diagram illustrating a relation between the movable components illustrated in FIGS. 2A, 2B and 6, and gears that transmit drive forces to the movable components.

In FIG. 13, since a drive force from an output gear of the first motor M1 is transmitted to a gear 280G integrated with the shaft 280, via a relay gear 295, the drive force is transmitted to the pick pusher 70 (FIG. 6) integrated with the shaft 280. The gear 280G further transmits the drive force to a gear 101G integrated with the feed roller shaft 101 via a relay gear 296 to drive the feed roller shaft 101.

A drive force from the second motor M2 is transmitted to the transmission gear 292 integrated with the shaft 290 via the gear group 294 in the storage processing unit U2. The axial cores of the second reverse rollers 267 are fixed to the shaft 290.

Subsequently, the transmission gear 292 transmits the drive force to a gear 512bG integrated with the shaft of the return roller 512b on the drive side via a relay gear 298.

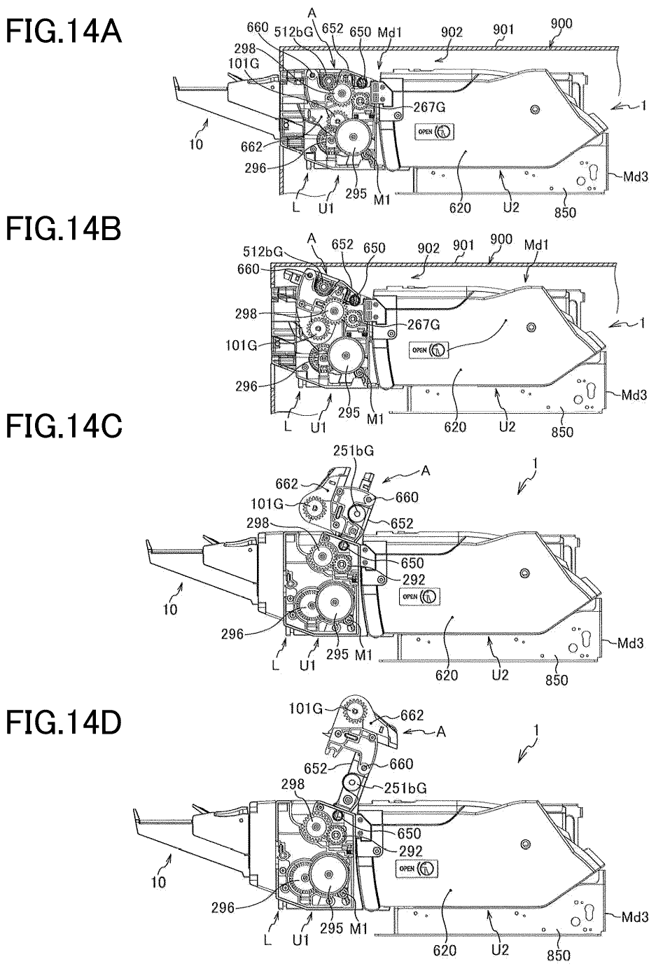

FIGS. 14A to 14D illustrate a process in which the rotationally-moving open/close mechanism A rotationally moves from an initial position to a third open position, and illustrate which gears are mounted on the first movable base 652 and the second movable base 662.

The gear 512bG integrated with the shaft of the return roller 512b is mounted on the first movable base 652. The gear 101G integrated with the feed roller shaft 101 is mounted on the second movable base 662.

The positions of the gears 512bG and 101G in FIGS. 14A, 14B, 14C and 14D correspond to the return roller 512b and the feed roller shaft 101 in FIGS. 2A, 2B 3A, 3C, 4A and 4B.

### Summary of Configuration, Action and Effect of the Embodiments of the Present Invention

A paper sheet separation transport device according to one embodiment of the present invention includes a first module Md1, including a paper sheet reception processing unit U1, and a paper sheet storage processing unit U2 coupled and fixed to the processing unit U1, a downstream module Md2 or Md3 removably coupled to the first module Md1 (the unit U2), and a controller 1000 that controls various control targets, and wherein the paper sheet reception processing unit U1 includes a frame 600 including an opening 602 on a front surface to receive paper sheets, a paper feed tray 10 removably attached to the front surface of the frame 600 to have a paper sheet bundle placed thereon, a set-out roller 30 that sets out paper sheets from a paper sheet bundle B on the paper feed tray 10, a feed roller 110 and a frictional separating member 130 constituting a separating part 100 that separates paper sheets set out by the set-out roller 30 in a multi-fed state into one sheet, a drawing transport part 250 that draws out one paper sheet B1 separated by the separating part 100 to send the paper sheet downstream (toward the paper sheet storage processing unit U2), and an axis support part 650, 660 that supports at least the set-out roller 30 and the feed roller 110 on the frame 600 about an axis to be rotationally movable (pivotable) between a processing enable position where processing (set-out and separation) of paper sheets is enabled and a processing disable position where processing of paper sheets is disabled.

The feed roller 110 is at a position (the transport processing enable position) close to the drawing transport part 250 when the set-out roller 30 and the feed roller 110 are at the processing enable position, and the feed roller 110 is separated from the drawing transport part 250 when the set-out roller 30 and the feed roller 110 are retracted to the processing disable position.

When a jam (paper jamming) occurs in the paper sheet reception processing unit U1 including the set-out part 20, the separating part 100, the drawing transport part 250, and a return transport route 510 and when the jam is located in a range that can be visually recognized from the opening 602 formed by removal of the paper feed tray 10, the jam can be processed through the opening 602. However, in processing a banknote jammed in a deeper part that cannot be visually recognized from the opening 602, inner components, particularly, the set-out roller 30, the feed roller 110, and the like become obstacles. With the embodiments of the present invention, at least the set-out roller 30 and the feed roller 110 are configured to be integrally rotationally moved upward on the first axis support part 650 and can be retracted. Accordingly, a banknote jammed at a jam occurrence position behind members that have been obstacles in visual recognition and jam processing from the opening 602 can be processed through the opening 602.

When the banknote separation transport device 1 is attached to the attachment part 902 of the paper sheet handling device, the ceiling of the attachment part 902 becomes an obstacle and there is a limitation in the angle at which the movable bases 652 and 662 are rotationally moved upward. Therefore, there is a limitation in processing of a jammed banknote located in a deep part through the opening 602. To enable such a problem to be addressed, the rotationally-moving open/close mechanism A (the movable bases 652, 662) is opened to the maximum by detaching the banknote separation transport device 1 from the attachment part 902, so that jam processing and other maintenance can be performed from outside the banknote separation transport device 1.

In the paper sheet separation transport device 1 according to another embodiment, the paper sheet storage processing unit U2 includes a storage transport mechanism 400 that receives a paper sheet sent from the paper sheet reception processing unit U1 to transport the paper sheet to the downstream module Md2 or Md3, and a recognition unit 450 that recognizes a paper sheet transported in the storage transport mechanism, and the controller 1000 executes control to reversely rotate the storage transport mechanism to reversely transport a paper sheet toward the paper sheet reception processing unit U1 when a paper sheet being taken in by the storage transport mechanism on the basis of a recognition result by the recognition unit 450 is judged to be inappropriate for transport to the downstream module Md2 or Md3.

The paper sheet reception processing unit U1 further includes a first transport mechanism (a first transport route) T1 that transports a paper sheet having been sent from the drawing transport part 250 toward the paper sheet storage processing unit U2, and a second transport mechanism (a second transport route) T2 that performs return transport of a paper sheet to a return paper sheet accumulating part 11 that receives paper sheets having been reversely sent from the paper sheet storage processing unit U2. The axis support part includes a first axis support part 650 that supports a first movable base 652 about an axis to be rotationally movable with respect to the frame 600, and a second axis support part 660 that supports a second movable base 662 about an axis to be rotationally movable with respect to the first movable base 652, at least some of transport components constituting the second transport mechanism T2 are mounted on the first movable base 652, and at least the set-out roller 30, the feed roller 110, and others of transport components constituting the first transport mechanism are mounted on the second movable base 662.

In a state where the banknote separation transport device 1 is separated from the banknote handling device 900 as shown in FIGS. 4A and 4B, a jam occurring on the return banknote transport route 510 constituting the second transport mechanism T2 is difficult to process only by retracting the set-out roller 30 and the feed roller 110 as shown in FIGS. 4A and 4B. Accordingly, with the embodiments of the present invention, the set-out roller 30, the feed roller 110, and one of the return rollers 512a are mounted on the second movable base 662 while the other return roller 512b is mounted on the first movable base 652 that supports the second movable base 662 about an axis to be rotationally movable. In this way, the structure enables two phases of opening and closing. Therefore, the return transport route 510 is opened by rotationally moving (opening) the second movable base 662 with respect to the first movable base 652 as shown in FIGS. 5A and 5B, so that maintenance of rollers and sensors in the return transport route 510 in an exposed state can be performed as well as the jam processing.

The paper sheet separation transport device 1 according to another embodiment includes a latch mechanism 700 that causes the set-out roller 30 and the feed roller 110 to be caught at the processing enable position in an initial state and that cancels the catch to allow the set-out roller 30 and the feed roller 110 to rotationally move to the processing disable position when a cancelling operation is performed.

The latch mechanism 700 includes a first cancel mechanism R1 that enables a cancelling operation from front only in a state where the paper feed tray 10 is removed from the paper sheet reception processing unit U1, and a second cancel mechanism R2 that enables a cancelling operation from a direction other than the front in a state where the paper feed tray 10 is attached to the paper sheet reception processing unit U1.

When processing of a jam occurring in the banknote separation transport device 1 is performed in a state where the banknote separation transport device 1 is attached to the banknote handling device 900, it is convenient that processing of an inner part is performed through an opening 602 exposed by detachment of the paper feed tray 10. However, processing of a jam in a deep part that cannot be visually recognized or processed from the opening 602 at that time is difficult unless components such as the set-out roller 30 and the feed roller 110 that are in front of the jam and that become obstacles are retracted. With the embodiments of the present invention, these components that become obstacles are mounted on the second movable base 662 and are retracted about an axis support part. The first and second cancel mechanisms R1 and R2 constituting the latch mechanism 700 locate components that become obstacles at a position enabling banknote transport in the initial state, to bring the components to a state where the normal operation can be performed. When processing of a jam occurs in a deep part of the device 1, the first and second cancel mechanisms R1 and R2 enable the impeditive components to be retracted by a one-touch operation.

The first cancel mechanism R1 enables a cancelling operation from the front in a state where the opening 602 is exposed. When a cancelling operation is performed, the impeditive components for the jam processing spring up due to elastic members.

The second cancel mechanism R2 enables a cancelling operation from a direction other than the front in a state where the paper feed tray 10 remains attached to the paper sheet reception processing unit U1 in a state where the banknote separation transport device 1 is separated from the banknote handling device 900.

In the paper sheet separation transport device according to another embodiment, the latch mechanism 700 includes a latch member 702 that is provided on the second movable base 662 to be capable of advancing or retracting in the lateral direction and that is caught on or released from a fixed-side catch part 630 provided at a fixed part (a frame) 611, an elastic member 704 that biases the latch member 700 in a direction to be caught on the fixed-side catch part 630, a first cancel operation part 702b that is provided on the latch member 700 and that moves the latch member 700 in a direction to be released from the fixed-side catch part 630 by an operation from the front (the side of the opening), and a cancelling piece 710 that is provided on the fixed part to be capable of advancing and retracting in the lateral direction and that moves the latch member 700 in a direction to be released from the fixed-side catch part 630 by an operation in a direction different from the front (from outside of the fixed part).

Furthermore, the latch mechanism 700 keeps a state where the latch member 700 is caught on the fixed-side catch part 630 when the set-out roller 30 and the feed roller 110 supported by the second movable base 662 are at a transport enable position (a processing enable position), and allows the set-out roller 30 and the feed roller 110 to be movable to the processing disable position when a cancelling operation is performed to the first cancel operation part 702b or the second cancel operation part 710a.

The paper sheet separation transport device 1 according to another embodiment includes a lock mechanism L that removably couples the first module Md1 to the downstream module Md2 or Md3, in which the lock mechanism L includes a release operation piece 750 that is supported by a fixed part 611 of the paper sheet reception processing unit U1 to be capable of advancing and retracting in a front-back direction, an operated piece 770 that is supported about an axis by a shaft 770a provided on a fixed part 620 of the paper sheet storage processing unit U2 to be rotationally movable and that is operated by the release operation piece 750 to rotationally move, and a lock piece 775 that is supported about an axis by a shaft 775a provided at the fixed part 620 to be rotationally movable and that rotationally moves between a locked attitude where the lock piece 775 is caught on a fixed part 850 of the downstream module Md2 or Md3 and an unlocked attitude where the catch is canceled, and the operated piece 770 actuates the lock piece 775 in a direction of unlock by pushing backward of the release operation piece 750 or pulling frontward thereof.

When the release operation piece 750 is operated (pushed or pulled), the lock piece 775 having been caught on the fixed part acts in the separating direction, and the units U1 and U2 (the coupled units) that are coupled can be integrally detached from the downstream module Md2 or Md3. This enables the rotationally-moving open/close mechanism A to be widely opened while the paper feed tray 10 remains attached (without using the narrow opening 602), and maintenance such as jam processing, removal of foreign objects, cleaning of the lens of the tracking sensor, and cleaning for preventing reduction in the grip of the transport rollers can be performed in every corner.

For example, when a client who wants manufacturing of a banknote handling device 900 makes a request to allow employees not having a special managing authority to access a cashbox to perform attachment and detachment of the units U1 and U2 for jam processing, such a request can be met.

Some clients make a request to allow employees to only accesses from the opening 602 at the time of jam processing, that is, not to allow employees to attach or detach the coupled units U1 and U2. In this case, it suffices to cover the button 750a of the release operation piece 750 to prevent the button 750a from being operated.

The paper sheet separation transport device can realize separation driving with a high operation reliability and enhance the maintenance performance of jam processing by being applied to a paper sheet handling device such as a banknote deposit machine, a banknote counting machine, or various type of automatic vending machines, while being small in the size.

Although the invention has been described in detail with reference to several embodiments, additional variations and modifications exist within the scope and spirit of the invention as described and defined in the following claims.

What is claimed is:

1. A paper sheet separation transport device comprising:
a first module in which a paper sheet reception processing unit is fixed to a paper sheet storage processing unit, a downstream module removably coupled to the first module, and a controller that controls various control targets;
wherein the paper sheet reception processing unit includes a frame including an opening on a front surface to receive paper sheets, a paper feed tray removably attached to the frame, a set-out roller that sets out paper sheets from a paper sheet bundle on the paper feed tray, a feed roller and a frictional separating member including a separating part that separates paper sheets set out by the set-out roller in a multi-fed state into one sheet, a drawing transport part that draws out one paper sheet separated by the separating part to send the paper sheet downstream, and an axis support part that supports at least the set-out roller and the feed roller on the frame about an axis pivotable between a processing enable position and a processing disable position; and
wherein the feed roller is at a position adjacent to the drawing transport part when the set-out roller and the feed roller are at the processing enable position, and the feed roller is separated away from the drawing transport part when the set-out roller and the feed roller are at the processing disable position.

2. The paper sheet separation transport device according to claim 1, wherein:
the paper sheet reception processing unit includes a first transport mechanism that transports a paper sheet having been sent from the drawing transport part toward the paper sheet storage processing unit, and a second transport mechanism that performs return transport to a return paper sheet accumulating part that receives paper sheets having been reversely sent from the paper sheet storage processing unit;
the axis support part includes a first axis support part that supports a first movable base about an axis to be rotationally movable with respect to the frame, and a second axis support part that supports a second movable base about an axis to be rotationally movable with respect to the first movable base;
at least one or more components forming the second transport mechanism are mounted on the first movable base; and
at least the set-out roller and the feed roller of the first transport mechanism are mounted on the second movable base.

3. The paper sheet separation transport device according to claim 2, further comprising:
a latch mechanism that causes the set-out roller and the feed roller to be caught at the processing enable position in an initial state and that cancels the catch to allow the set-out roller and the feed roller to rotationally move to the processing disable position when a cancelling operation is performed; and
wherein the latch mechanism comprises a first cancel mechanism that enables a canceling operation from front only in a state where the paper feed tray is removed from the paper sheet reception processing unit, and a second cancel mechanism that enables a cancelling operation from a direction other than the front in a state where the paper feed tray is attached to the paper sheet reception processing unit.

4. The paper sheet separation transport device according to claim 3, wherein:
the latch mechanism comprises a latch member that is provided on the second movable base to be capable of advancing or retracting and that is caught on or released from a fixed-side catch part provided at a fixed part, an elastic member that biases the latch member in a direction to be caught on the fixed-side catch part, a first cancel operation part that is provided on the latch member and that moves the latch member in a direction to be released from the fixed-side catch part by an operation from front, and a second cancel operation part that is provided on the fixed part to be capable of advancing and retracting and that moves the latch member in a direction to be released from the fixed-side catch part by an operation in a direction different from the front, and
the latch mechanism keeps a state where the latch member is caught on the fixed-side catch part when the set-out roller and the feed roller supported by the second movable base are at the processing enable position, and allows the set-out roller and the feed roller to move to the processing disable position when a cancelling operation is performed to the first cancel operation part or the second cancel operation part.

5. The paper sheet separation transport device according to claim 1 further comprising:
a lock mechanism that removably couples the first module to the downstream module, wherein
the lock mechanism includes a release operation piece that is supported by a fixed part of the paper sheet reception processing unit to be capable of advancing and retracting in a front-back direction, an operated piece that is supported about an axis by a shaft, which is provided on a fixed part of the paper sheet storage processing unit, to be rotationally movable and that is operated by the release operation piece to rotationally move, and a lock piece that is supported about an axis by a shaft, which is provided at a fixed part of the paper sheet storage processing unit, to be rotationally movable and that rotationally moves between a locked attitude where the lock piece is caught on a fixed part of the downstream module and an unlocked attitude where the catch is canceled; and
the operated piece actuates the lock piece in a direction of unlock by pushing backward of the release operation piece or pulling frontward thereof.

6. A paper sheet handling device comprising the paper sheet separation transport device according to claim 1.

7. A paper sheet handling device comprising the paper sheet separation transport device according to claim 2.

8. A paper sheet handling device comprising the paper sheet separation transport device according to claim 3.

9. A paper sheet handling device comprising the paper sheet separation transport device according to claim 4.

10. A paper sheet handling device comprising the paper sheet separation transport device according to claim 5.

11. A paper sheet separation transport device comprising:
a first module in which a paper sheet reception processing unit is fixed to a paper sheet storage processing unit, a downstream module removably coupled to the first module, and a controller that controls various control targets;
wherein the paper sheet reception processing unit includes a frame including an opening on a front surface to receive paper sheets, a paper feed tray removably attached to the front surface of the frame, a set-out roller that sets out paper sheets from a paper sheet bundle on the paper feed tray, a feed roller and a frictional separating member comprising a separating part that separates paper sheets set out by the set-out roller in a multi-fed state into one sheet, a drawing transport part that draws out one paper sheet separated by the separating part to send the paper sheet downstream, and an axis support part that supports at least the set-out roller and the feed roller on the frame about an axis to be pivotable between a processing enable position where paper sheet transport processing is enabled and a processing disable position where paper sheet transport processing is disabled, and
wherein the feed roller is at a position adjacent to the drawing transport part when the set-out roller and the feed roller are at the processing enable position, and the feed roller is separated away from the drawing transport part when the set-out roller and the feed roller are retracted to the processing disable position.

12. The paper sheet separation transport device according to claim 11, wherein:
the paper sheet reception processing unit includes a first transport mechanism that transports a paper sheet having been sent from the drawing transport part toward the paper sheet storage processing unit, and a second transport mechanism that performs return transport to a return paper sheet accumulating part that receives paper sheets having been reversely sent from the paper sheet storage processing unit;
the axis support part includes a first axis support part that supports a first movable base about an axis to be rotationally movable with respect to the frame, and a second axis support part that supports a second movable base about an axis to be rotationally movable with respect to the first movable base;
at least one or more components forming the second transport mechanism are mounted on the first movable base; and
at least the set-out roller and the feed roller of the first transport mechanism are mounted on the second movable base.

13. The paper sheet separation transport device according to claim 12, further comprising:
a latch mechanism that causes the set-out roller and the feed roller to be caught at the processing enable position in an initial state and that cancels the catch to allow the set-out roller and the feed roller to rotationally move to the processing disable position when a cancelling operation is performed; and
wherein the latch mechanism comprises a first cancel mechanism that enables a canceling operation from front only in a state where the paper feed tray is removed from the paper sheet reception processing unit, and a second cancel mechanism that enables a cancelling operation from a direction other than the front in a state where the paper feed tray is attached to the paper sheet reception processing unit.

14. The paper sheet separation transport device according to claim 13, wherein:
the latch mechanism comprises a latch member that is provided on the second movable base to be capable of advancing or retracting and that is caught on or released from a fixed-side catch part provided at a fixed part, an elastic member that biases the latch member in a direction to be caught on the fixed-side catch part, a first cancel operation part that is provided on the latch member and that moves the latch member in a direction to be released from the fixed-side catch part by an operation from front, and a second cancel operation part that is provided on the fixed part to be capable of advancing and retracting and that moves the latch member in a direction to be released from the fixed-side catch part by an operation in a direction different from the front, and
the latch mechanism keeps a state where the latch member is caught on the fixed-side catch part when the set-out roller and the feed roller supported by the second movable base are at the processing enable position, and allows the set-out roller and the feed roller to move to the processing disable position when a cancelling operation is performed to the first cancel operation part or the second cancel operation part.

15. The paper sheet separation transport device according to claim 11 further comprising:
a lock mechanism that removably couples the first module to the downstream module, wherein
the lock mechanism includes a release operation piece that is supported by a fixed part of the paper sheet reception processing unit to be capable of advancing and retracting in a front-back direction, an operated piece that is supported about an axis by a shaft, which is provided on a fixed part of the paper sheet storage processing unit, to be rotationally movable and that is operated by the release operation piece to rotationally move, and a lock piece that is supported about an axis by a shaft, which is provided at a fixed part of the paper sheet storage processing unit, to be rotationally movable and that rotationally moves between a locked attitude where the lock piece is caught on a fixed part of the downstream module and an unlocked attitude where the catch is canceled; and
the operated piece actuates the lock piece in a direction of unlock by pushing backward of the release operation piece or pulling frontward thereof.

16. A paper sheet handling device comprising the paper sheet separation transport device according to claim 11.

17. A paper sheet handling device comprising the paper sheet separation transport device according to claim 12.

18. A paper sheet handling device comprising the paper sheet separation transport device according to claim 13.

19. A paper sheet handling device comprising the paper sheet separation transport device according to claim 14.

20. A paper sheet handling device comprising the paper sheet separation transport device according to claim 15.
